(19) United States
(12) Patent Application Publication
(10) Pub. No.: US 2003/0183694 A1
(43) Pub. Date: Oct. 2, 2003

(54) Ticketing method and system having a ticket object and an associated marker object

(76) Inventors: Craig Peter Sayers, Menlo Park, CA (US); Martin Lew is Griss, Palo Alto, CA (US); Bernard Joseph Burg, Menlo Park, CA (US)

Correspondence Address: HEWLETT-PACKARD COMPANY, Intellectual Property Administration, P.O. Box 272400, Fort Collins, CO, 80527-2400, US

(21) Appl. No.: 10/114,490

(22) Filed: Apr. 1, 2002

(51) Int. Cl. G06K 19/00

(52) U.S. Cl. 235/487

(57) ABSTRACT

A ticketing method and system. A ticket object includes identifying information. A marker object is associated with the ticket object. The marker object includes information describing a relationship to the ticket object with reference to the identifying information. The marker object also includes information defining a privilege provided by its association with the ticket object. The privilege is granted upon use of the marker object.

### TECHNICAL FIELD

Embodiments of the present invention relate to ticketing systems and methods. More specifically, embodiments of the present invention pertain to a ticketing method and system having a ticket object and an associated marker object.

### BACKGROUND ART

The conventional ticketing paradigm holds that a ticket is purchased for a particular venue, and seating is either assigned at the time of purchase or at the venue on a first-come, first-served basis. However, there are a number of problems and inconveniences associated with this paradigm.

Pre-assigned seating is problematic because seats remain empty if the ticket holder does not show up. Pre-assigned seating is also problematic because it makes it difficult for people to sit together unless they purchase their tickets at the same time. In general, pre-assigned seating is inflexible, providing no systematic approach for allowing seating in other than the assigned location.

First-come, first-served (e.g., general admission) seating is also problematic. If people want to sit together, they typically need to arrive at the same time. Although seats can be saved, this can be difficult, especially if the group is relatively large. The act of saving seats is also not a formal process, and people attempting to save seats generally rely on the goodwill and cooperation of others. Should someone decide not to cooperate, the person saving the seats has little recourse but to yield. Moreover, there is no disincentive to prevent people from saving more seats than they might need. The venue in particular has little incentive to either help people save seats or prevent them from doing so.

Airlines, for example, are able to make some accommodation for seating people together when tickets are not purchased at the same time. However, the mechanisms for accomplishing this are inefficient. For instance, two colleagues may meet at the airport and learn that they are traveling on the same flight. In order to get seats together, both must approach the ticketing agent because, generally, an agent will not move the passengers to adjacent seats without knowing that both passengers consent to such a move.

The airline example can be used to illustrate another problem with the conventional ticketing paradigm. Consider the case in which there is a need to know if someone is on a particular flight. This situation can occur, for example, when a limousine driver, expecting a client on a particular flight, wishes to know if the client is actually on that flight. For security reasons, airlines will typically only provide information about the arrival time of the flight, but will not give out information about a specific passenger. Thus, a person with an interest in knowing information about a particular passenger is not able to readily obtain that information.

Accordingly, what is needed is a method and/or system that can 5address the problems described above. The present invention provides a novel solution to these problems.

### DISCLOSURE OF THE INVENTION

A ticketing method and system are described. A ticket object includes identifying information. A marker object is associated with the ticket object. The marker object includes information describing a relationship to the ticket object with reference to the identifying information. The marker object also includes information defining a privilege provided by its association with the ticket object. The privilege is granted upon use of the marker object.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1A illustrates one embodiment of a ticketing system having a ticket object and a marker object in accordance with the present invention.

FIG. 1B illustrates one example of a ticket with a marker according to one embodiment of the present invention.

FIG. 1C illustrates another example of marker objects according to one embodiment of the present invention.

FIG. 2A is a block diagram showing an exemplary ticketing system architecture upon which embodiments of the present invention may be implemented.

FIG. 2B is a data flow diagram for a ticketing process according to one embodiment of the present invention.

FIG. 3 is a flowchart of a ticketing method in accordance with one embodiment of the present invention.

FIG. 4 is a flowchart of one embodiment of a method for dynamically assigning seating in accordance with the present invention.

### BEST MODE FOR CARRYING OUT THE INVENTION

A ticketing method and system are described. According to the various embodiments of the present invention, one or more marker objects are associated with each ticket object. Marker objects can be distributed to other people at the behest of the holder of the ticket object. For example, in one embodiment, a ticket object is physically manifested as a printed ticket, and the marker objects are physically manifested as printed objects that can be separated from the ticket. In this embodiment, the ticket and the markers are encoded with information that can be read electronically. The information encoded in the markers identifies the markers as being associated with the ticket. Information in the markers also defines a privilege associated with the ticket; different markers may have different privileges. The use of the marker grants the person possessing it with the privilege encoded in the marker. For example, the marker may accord membership in a group that includes the ticket holder, so that the person holding the marker can be assigned a seat with (or near) the ticket holder, even if the tickets were not purchased at the same time. The marker may also accord access to secured information that would not be otherwise accessible, such as whether or not the ticket holder is on a particular airline flight.

In general, embodiments of the present invention provide a method and system that permit seats to be assigned dynamically, providing flexibility to the seat selection process, allowing groups of people to more readily sit together, and reducing the probability that seats, particularly desirable ones, will go unused. In essence, the present invention, in its various embodiments, combines the advantages of pre-assigned seating with the advantages of first-come, first-served seating, while overcoming the disadvantages of the prior art. Embodiments of the present invention also provide a method and system that allows secured information to be selectively shared with others. These and other advantages will become more apparent in light of the detailed discussion below.

The term “ticket,” as used herein, refers to some object or means that provides proof that admittance to a venue is authorized. The term “venue,” as used herein, refers to an arena, a theatre, an airplane, and other sites and places in which a ticket may be needed. The terms “ticket objects” and “marker objects” are used herein to encompass the various formats that may be used for tickets and markers. Ticket objects and marker objects may be in an electronically-readable format, a magnetically-readable format, an optically-readable format, a mechanically-readable format, or in some other format that provides for the exchange of information. Thus, tickets and markers may be realized as conventional printed objects that use bar codes or other types of markings to encode information. Tickets and markers may also be realized as “smart cards” that contain (store) encoded information using any of the above-mentioned formats. Furthermore, tickets and markers may be realized as information stored by a computer system (including personal digital assistants and other types of portable or hand-held devices); this information may be stored using any of the above-mentioned formats and exchanged with other devices via electronic mail, instant messaging, infrared beaming, radio signals, and other such mechanisms. For simplicity of discussion, ticket and ticket object, and marker and marker object, are used interchangeably herein.

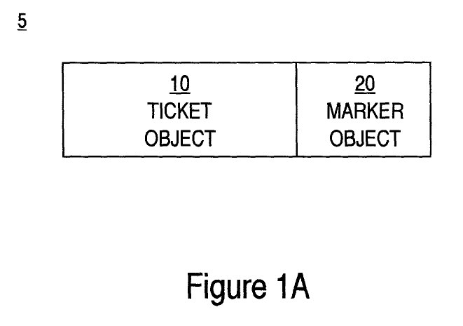

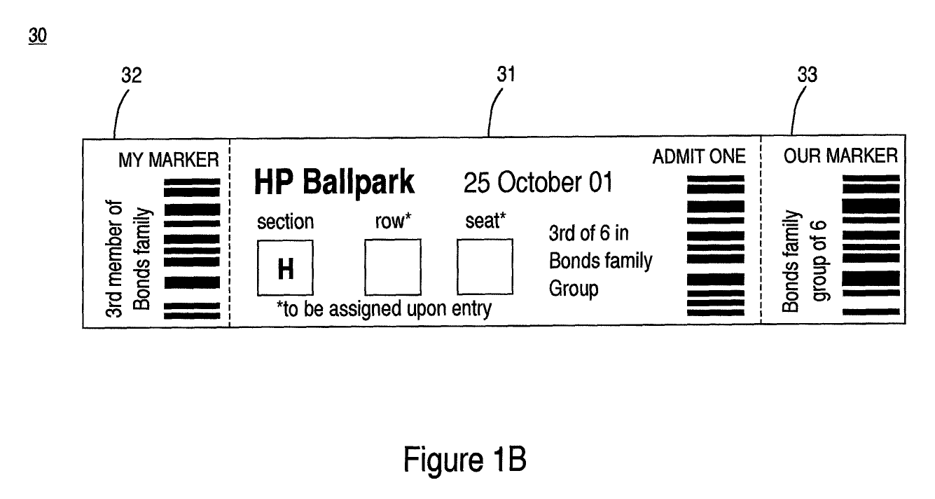

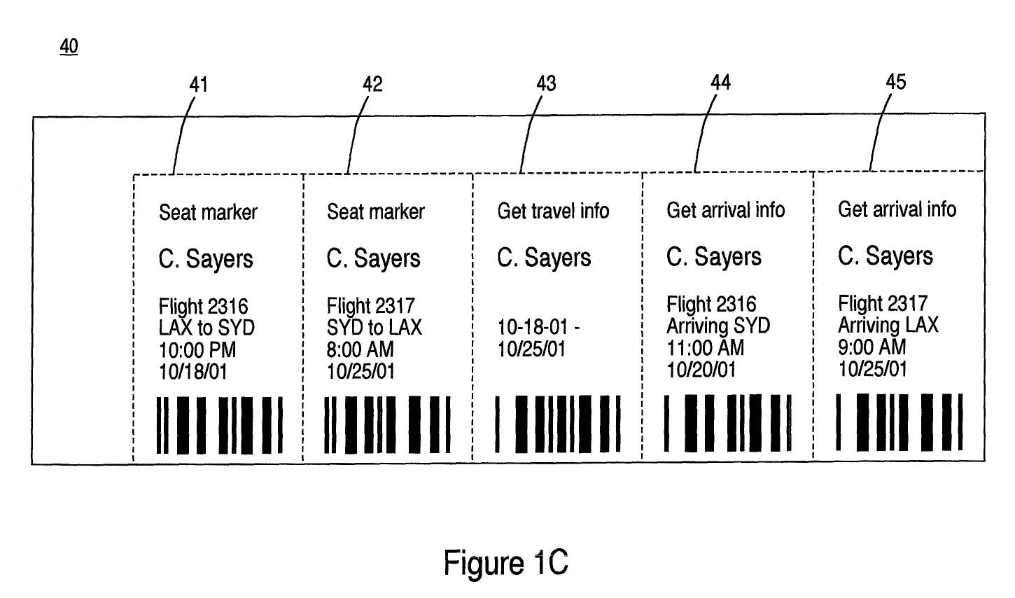

FIGS. 1A, 1B and 1C illustrate various embodiments of ticket objects and marker objects in accordance with the present invention. FIG. 1A provides a functional block diagram of a ticketing system 5. FIGS. 1B and 1C provide exemplary realizations of ticketing system 5 to more clearly describe the features provided by embodiments of the present invention.

With reference first to FIG. 1A, the functional components of a ticketing system 5 according to one embodiment of the present invention are shown. Ticketing system 5 includes a ticket object 10 and an associated marker object 20 (although it is appreciated that there may be multiple marker objects associated with a ticket object). Ticket object 10 includes some type of identifying information, which is used by marker object 20 as a reference to identify its association with ticket object 10. For example, ticket object 10 may include a group identifier (ID), which may also be included with marker object 20. Marker object 20 also includes information that defines a privilege provided by its association with ticket object 10. In the present embodiment, marker object 20 can be separated from and used independently of ticket object 10.

FIG. 1B illustrates an exemplary ticket 30 in accordance with one embodiment of the present invention. Ticket 30 can be used to gain admittance to a particular venue, for example. In the present embodiment, ticket 30 includes a ticket portion 31 and marker portions 32 and 33. In one embodiment, the marker portions 32 and 33 include information identifying their association with ticket portion 31. The marker portions 32 and 33 may be removed from ticket portion 31.

In the present embodiment, ticket 30 is issued and used as follows. When a ticket is purchased for a particular venue, the purchaser is provided with an option of having a specific seat assigned, of having a seat reserved in a particular section, or of having no seat assigned (e.g., general admission or first-come, first-served). The price of the ticket may be set according to which option is selected; that is, a higher price can be charged to reserve a specific seat, a lower price charged to reserve a seat in a particular section, and the lowest price charged for general admission. The remainder of this example pertains to the case in which the second or third option is selected. Under these options, a seat is assigned when the ticket bearer enters the venue.

When the ticket is purchased, the purchaser is also given the option of purchasing additional tickets. In the present embodiment, when a group of tickets is purchased, each ticket in the group is encoded with information identifying it as a member of the group. Specifically, in the present embodiment, ticket portion 31 and marker portions 32 and 33 each include a group ID. Also, marker portion 32 includes information associating it specifically with ticket 30, while marker portion 33 includes information associating it with the group with which ticket 30 is associated. In the illustrated embodiment, this information is encoded using bar codes. Note that when a single ticket is purchased, a group ID can still be assigned; in this case, the group simply has a size of one.

According to the present embodiment of the present invention, the bearer of ticket 30 can optionally distribute marker portion 32 and/or marker portion 33 to other people. Similarly, the bearer of ticket 30 can receive marker portions from other people.

In the present embodiment, ticket 30 is scanned at an entrance to the venue. In one embodiment, in response to the scanning, information is provided to the bearer; for example, the bearer can be informed as to whether any of the other members of the group has previously arrived. If the bearer is first to arrive, then seats are assigned to the bearer and to all members of the group. If someone from the group has arrived ahead of the bearer, then seats would be already reserved for the group, and so the bearer would be assigned one of those seats.

According to the present embodiment, the bearer of ticket 30 can also scan any markers received from others. If these people have not yet arrived, then scanning their markers has the effect of adding these people to the group associated with ticket 30. As such, when a seat is assigned to the bearer of ticket 30, adjacent or nearby seats (depending on the availability of seats) are also reserved for the people associated with each of the markers. In one embodiment, the bearer of ticket 30 is provided with information indicating where these seats are located.

In a similar fashion, the bearer of ticket 30 may have provided a marker to a person who scanned that marker prior to the arrival of the bearer of ticket 30. In this case, the bearer of ticket 30 would have been added to the group belonging to that person, and a seat for the bearer of ticket 30 will already have been assigned, as described above.

The process just described is repeated for each member of the group as they arrive. Each group member scans their ticket as well as any markers they have collected. In this manner, a group of people can be seated in adjacent seats, or in nearby seats, even though the tickets were not purchased at the same time. In addition, this service is accomplished more efficiently and securely than conventional means. For example, the use of marker objects makes this service more secure because the marker objects are in the possession of those people authorized to have them, and more efficient because it is easier to locate someone and arrange a seat near that person. Moreover, the process of saving seats is formalized, making it easier to save seats without having to rely on the goodwill of others. Thus, groups of people without pre-assigned seats can be seated together even if they do not arrive at the same time.

Significantly, the process of saving seats is placed under control of the venue, providing a number of other advantages. First, the venue has the opportunity to charge for this service, providing an opportunity for additional revenue. Second, the venue can exert greater control over the seat-saving process, so that people do not save more seats than they need; a seat is only saved when a marker is exchanged, and only a number of seats equal to the number of exchanged markers can be saved.

Of perhaps greater significance, embodiments of the present invention allow seating to be assigned dynamically, as people arrive at the venue. Dynamic seating can be used to ensure that desirable seats do not go unused. Dynamic seating also allows for further enhancements and advantages, for the venue and for its patrons, which are described further below.

First, however, reference is made to FIG. 1C, which illustrates an exemplary ticket 40 in accordance with another embodiment of the present invention. Ticket 40 can be used for airline travel, for example. In the present embodiment, ticket 40 includes a number of marker portions 41, 42, 43, 44 and 45. As in the example of FIG. 1B, the markers include information identifying their association with a separate ticket portion (not shown).

In the embodiment of FIG. 1C, different privileges are associated with each of the marker portions 41-45. Thus, for example, marker portions 41 and 42 can be given to others, so that they can request a seat adjacent to (or near) the bearer of ticket 40, or so they can determine whether the bearer of ticket 40 is on the flight and where he/she is seated. By exchanging markers, colleagues can more efficiently arrange to get seats together; both parties do not need to approach the ticket agent, for example, because possession of the markers provides implicit proof that both parties consent to moving seats.

The exchange of markers also allows travel information about a specific passenger to be made readily available to authorized parties. As mentioned, markers 41 and 42 can be given to travel companions, who can determine where the bearer of ticket 40 is seated, and whether the bearer of ticket 40 is still on the flight. Similarly, marker 43 can be used by someone to obtain all travel information pertaining to the bearer of ticket 40; marker 43 may be given to a family member, for example. Likewise, markers 44 and 45 can be given to someone who needs to know, to a limited extent, some portion of the travel information for the bearer of ticket 40. For example, marker 44 can be provided to a limousine driver, who can use marker 44 to learn whether a client is actually on a particular flight as expected.

Therefore, the present embodiment of the present invention allows information about a specific passenger to be provided to interested parties. In one embodiment, the scope of the information provided is limited to an amount prescribed by the passenger. The passenger controls which people can receive what information by selectively distributing markers 41-45. Thus, the distribution of information is facilitated, but only to a limited degree under the control of the individual. Other enhancements and advantages associated with the various embodiments of the present invention are described further below.

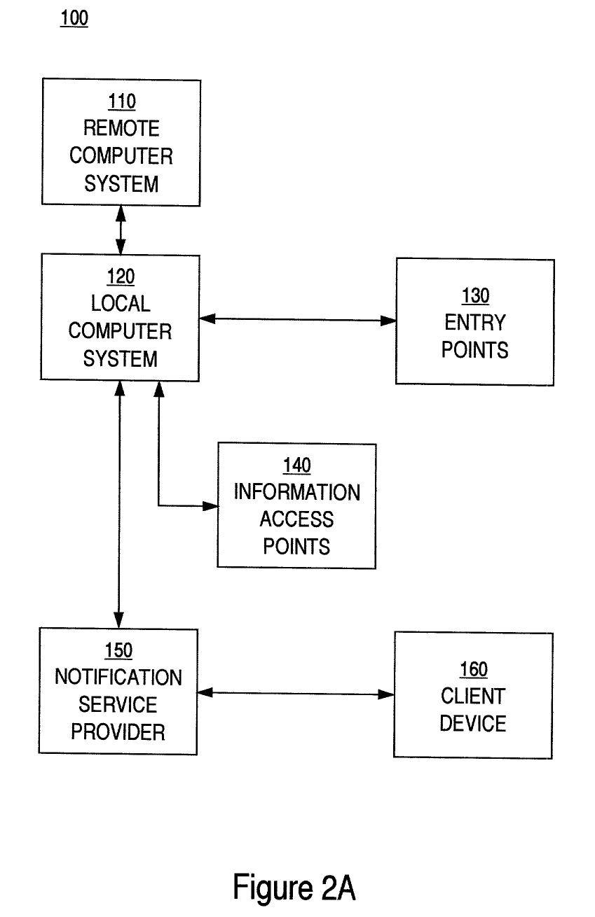

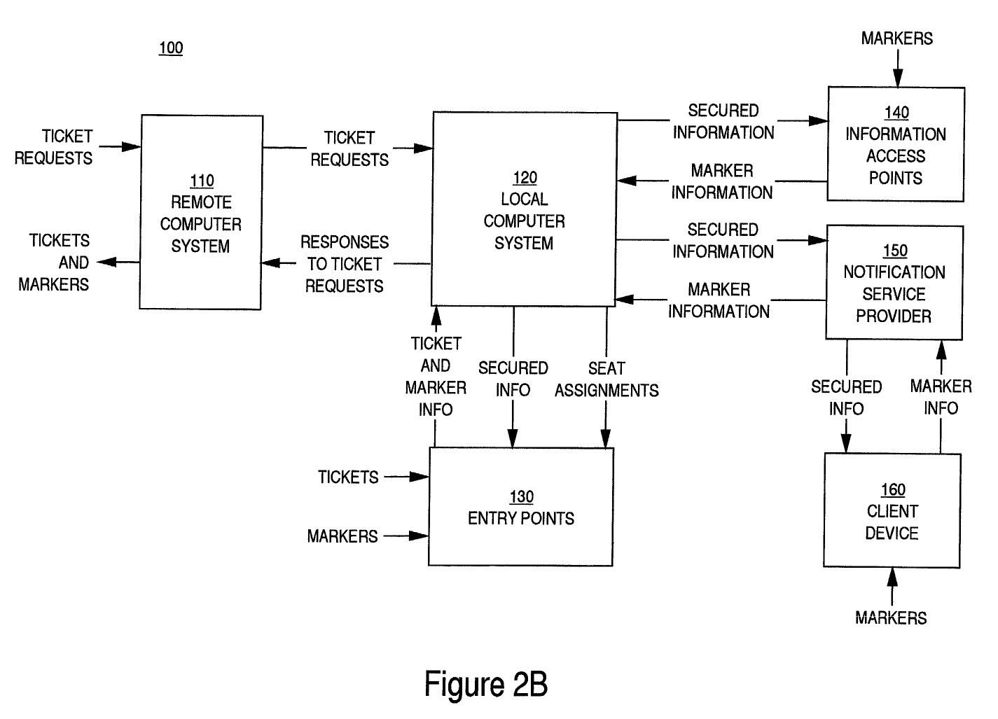

Reference is first made to FIG. 2A, which is a block diagram showing an exemplary ticketing system architecture 100 upon which embodiments of the present invention may be implemented. It is appreciated that embodiments of the present invention may be practiced without all of the elements shown in FIG. 2A, or that the functionalities provided by multiple elements may instead be provided by a single element. It is also appreciated that embodiments of the present invention may be practiced with elements in addition to those shown.

In the embodiment of FIG. 2A, remote computer system 110 is in communication with local computer system 120. Remote computer system 110 is for controlling the purchase and issuance of ticket objects and marker objects, and may service multiple venues. Local computer system 120 is for controlling the purchase and issuance of ticket objects and marker objects for a particular venue. Thus, according to the present embodiment, a ticket (with associated markers) can be purchased and/or issued for a particular venue via either remote computer system 110 or local computer system 120.

In the present embodiment, one or more entry points 130 are coupled to (in communication with) local computer system 120. Entry points 130 are used to control access to a venue. That is, a ticket holder must pass through an entry point 130 to enter/use a venue, and is only permitted to enter upon presentation of a proper ticket object. In one embodiment, entry points 130 have the capability to receive and/or read the information that is encoded in a ticket and/or marker object according to the various formats mentioned above. According to the present embodiment, when information from a ticket or marker object is received by one of the entry points 130, this information can be communicated to local computer system 120 and recorded in a database residing thereon.

Entry points 130 also have the capability to communicate information back to the bearer of the ticket/marker. For example, if the ticket is identified as being part of a group, the number of other group members that have already arrived can be communicated. Other types of information can be provided, as described in further detail below. Entry points 130 can present this information in any of a variety of formats. For instance, information may be visually displayed, audibly announced, printed, wirelessly communicated (e.g., to a personal digital assistant), or the like.

According to the present embodiment, a number of information access points 140 are also in communication with local computer system 120. Information access points 140 also have the capability to receive and/or read the information that is encoded in a ticket and/or marker object according to the various formats mentioned above. Upon being presented with a valid ticket and/or marker object, information access point 140 responds by providing an amount of information consistent with the access privileges accorded by the ticket and/or marker object. For example, if presented with a marker object that is identified as being associated with a particular group, the seating locations of the other members of the group can be provided. The amount of information provided is consistent with the access privileges accorded by the marker object. Other types of information can be provided, as described in further detail below. Information access points 140 can present this information in any of a variety of formats, in a manner similar to that described above. Information access points 140 are distinguishable from entry points 130 in that the former serve primarily as information sources, while the latter serve as both information sources and for controlling access to a venue. Information access points 140 may also be located remotely from the venue, while entry points 130 are generally located at the venue.

Continuing with reference to FIG. 2A, in the present embodiment, a notification service provider 150 is also in communication with local computer system 120. Notification service provider 150 performs a function analogous to that of information access points 140, but instead provides information to a remote client device 160. Remote client device 160 may be a computer system, a cell phone, a pager, a personal digital assistant, or the like. In this case, information from a ticket or marker object is entered into client device 160 and forwarded to notification service provider 150. Notification service provider 150 retrieves an amount of information consistent with the access privileges accorded by the ticket and/or marker object, and forwards this information to client device 160. Note that this process can be performed according to either a manual or an automated process. In the former case, information may be provided to client device 160 only in response to a request. In the latter case, information can be provided to client device 160 on a regular basis. Also, information can be provided automatically when there is a change in the information.

As noted, the various elements of ticketing system architecture 100 are in communication with each other. These elements may communicate over a wired network, a wireless network, or a hybrid wired/wireless network. Such a network may be a proprietary (private) network or it may utilize portions of more public networks (such as the Internet) with appropriate security measures.

FIG. 2B is a data flow diagram for ticketing system architecture 100 according to one embodiment of the present invention. In this embodiment, a request for a ticket is made to remote computer system 110. The request is communicated to local computer system 120, which responds to remote computer system 110 with information regarding ticket availability. Remote computer system 110 can then issue tickets and markers accordingly. Alternatively, ticket requests can be made directly to local computer system 120, and local computer system 120 can directly issue tickets and markers in response.

Tickets and/or markers are subsequently received at entry points 130. Entry points 130 communicate the ticket and/or marker information to local computer system 120. Based on the information in the tickets/markers, local computer system 120 assigns seats if seats have not already been assigned, as described above. If seats have been assigned, then local computer system 120 retrieves the seat assignments from a database. Local computer system 120 can then communicate the seat assignments to entry points 130.

In the present embodiment, local computer system 120 also can communicate secured information (such as seating information, travel information and the like) to entry points 130, information access points 140, and notification service provider 150. Notification service provider 150 in turn can communicate secured information to client device 160. In the present embodiment, the secured information is provided in response to the receipt of marker information indicating that the secured information can be shared (it is understood that ticket information can also be used to obtain secured information). The marker information is received by entry points 130, information access points 140, or notification service provider 150 (via client device 160), and forwarded to local computer system 120. Local computer system 120 can then respond with the appropriate amount of secured information; the amount of secured information that is provided depends on the access level specified by the marker information.

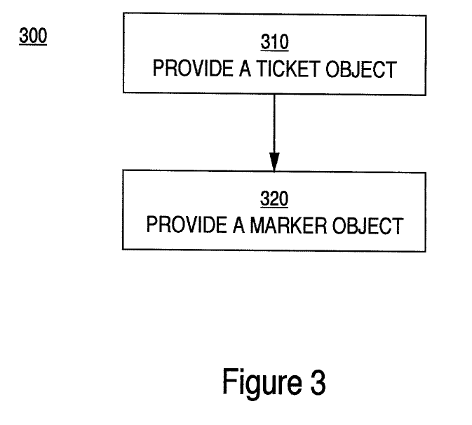

FIG. 3 is a flowchart 300 of a ticketing method in accordance with one embodiment of the present invention. Flowchart 300 includes processes of the present invention that, in one embodiment, are carried out by a processor under the control of computer-readable and computer-executable instructions. Although specific steps are disclosed in flowchart 300, such steps are exemplary. That is, the present invention is well suited to performing various other steps or variations of the steps recited in flowchart 300. It is appreciated that the steps in flowchart 300 may be performed in an order different than presented, and that not all of the steps in flowchart 300 may be performed.

In step 310 of FIG. 3, in the present embodiment, a ticket object is provided. The ticket object includes identifying information; in one embodiment, the identifying information identifies a group.

In step 320 of FIG. 3, according to the present embodiment, a marker object associated with the ticket object of step 310 is also provided. The marker object includes information that describes a relationship to the ticket object; in one embodiment, the identifying information of the ticket object is used to associate the ticket object and the marker object. That is, for example, both the ticket object and the marker object can include the same group ID. The marker object also includes information that defines a privilege provided by virtue of its association with the ticket object. This privilege is granted upon use of the marker object.

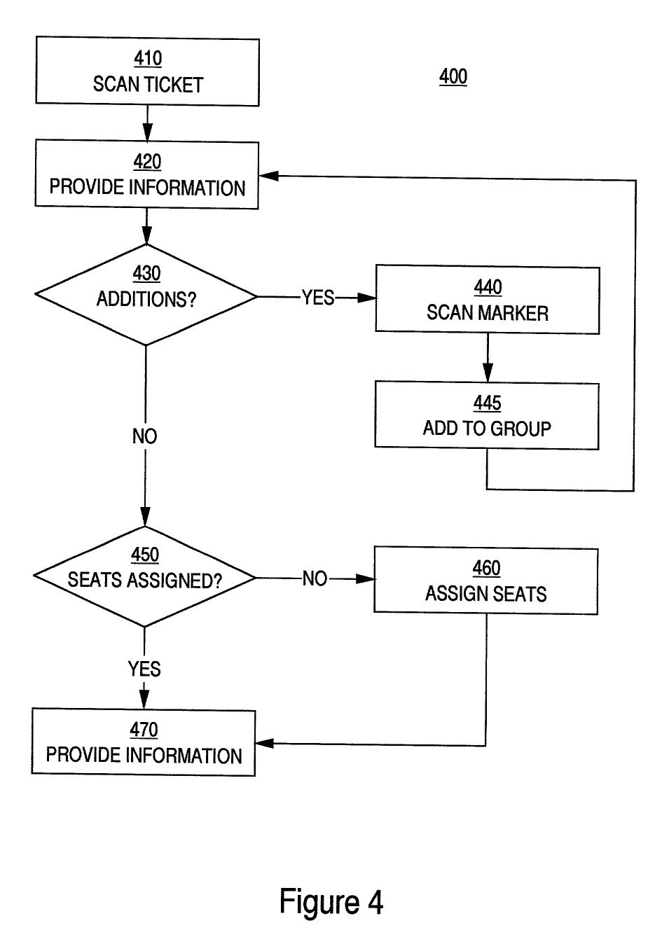

FIG. 4 is a flowchart 400 of one embodiment of a method for dynamically assigning seating in accordance with the present invention. Flowchart 400 includes processes of the present invention that, in one embodiment, are carried out by a processor under the control of computer-readable and computer-executable instructions. Although specific steps are disclosed in flowchart 400, such steps are exemplary. That is, the present invention is well suited to performing various other steps or variations of the steps recited in flowchart 400. It is appreciated that the steps in flowchart 400 may be performed in an order different than presented, and that not all of the steps in flowchart 400 may be performed.

In step 410 of FIG. 4, in the present embodiment, a ticket object is scanned and information from the ticket object is received. Recall that this ticket object is associated with a group (including a group of size one), and that ticket objects from other group members may have been scanned in advance of this ticket object.

In step 420, in the present embodiment, information is provided regarding, for example, any seats assigned including seats assigned to other group members. Other information may be provided depending on the various features of the present invention that are being implemented (refer to the enhancements described further below). In step 430, if there are no additions to be made to the group, then flowchart 400 proceeds to step 450. If there are additions, then flowchart 400 proceeds to step 440.

In step 440 of the present embodiment, a marker object is scanned and information from the marker object is received. In step 445, according to the present embodiment, the individual or group identified by that marker object is added to the group associated with the ticket object (from step 410). Note that, in a similar manner, people can also be deleted from the group. Flowchart 400 then returns to step 420, and steps 430, 440 and 445 are repeated for any other marker objects.

In step 450, in the present embodiment, a determination is made with regard to whether specific seats have already been assigned to all members of the group (e.g., because another member of the group arrived earlier). If no more seats are needed, then flowchart 400 proceeds to step 470; otherwise, flowchart 400 proceeds to step 460.

In step 460, specific seats are assigned with a goal of seating everyone in the group as close to each other as possible. In step 470, information is provided regarding the seat assigned to the ticket holder, the seats assigned to other group members, and the like.

The present embodiment of the present invention thus provides a method and system for dynamically assigning seats. Groups of people can be seated together even when the tickets are not purchased at the same time, and even when the people do not arrive at the venue at the same time. It is appreciated that there are a number of other advantages and enhancements that can be introduced in various other embodiments of the present invention. These are described below.

In one embodiment, the information included in the ticket and marker objects can be personalized to include the ticket holder's name, or some other user-friendly name that allows the ticket holder to be more readily identified to others. These names can be used to more readily identify who is sitting where, for example.

In another embodiment, as ticket holders enter a venue, they can be presented with an option to reserve seats for only a subset of the group (for example, when it is known that someone in the group will not be showing up). Thus, unused seats can be readily made available for others. The venue can establish a repository for unused and unwanted tickets and make provisions for refunds based on a number of factors, such as the popularity of the event. The venue can proffer a refund in anticipation of reselling the ticket, or the venue can resell the ticket and refund all of or a portion of the resale price, perhaps minus a commission. Thus, it may be possible for the refund to actually exceed the original purchase price of the ticket. It is also possible that forms of compensation other than monetary compensation may be used; for example, the equivalent of frequent flyer miles may be awarded.

In one embodiment, to help ensure that patrons do not reserve more seats than they will need for their group, a fee may be charged for each assigned seat, with a refund provided when the owner of the seat arrives to fill it. Alternatively, a charge may be made if more seats are reserved than it turns out are needed. The charge may be dynamic based on, for example, the amount of time remaining until the beginning of the event. Likewise, the amount of a refund or the resale value of a ticket can be dynamic. The current amount being offered for refunds and resales can be displayed or otherwise provided to ticket bearers, allowing them to make a decision on whether they want to use or sell their tickets.

Because seating is dynamic, ticket prices can be dynamic as well. Venues might offer a refund of a portion of the face value of a ticket to patrons who enter the venue early. Available seats could then be sold, with the price of these seats also varying dynamically based on supply and demand. As ticket holders enter a venue, they can be presented with seating options regarding, for example, which part of a venue they wish to be seated or whether they want a particular seat on an airplane (e.g., aisle or window), based on the current demand and the dynamic pricing. Similarly, patrons can be presented with options based on time rather than seating location. For example, at an amusement park, patrons can use their tickets/markers to reserve a particular time so that they can ride a particular attraction together. An advantage to the patrons is that they do not need to be together to reserve the time; one patron can use the marker from another, as well as his/her own ticket, to reserve the time. If by chance both patrons independently attempt to reserve times, the system will inform the second person that the other person has already reserved a time.

Patrons can also be presented with an option of upgrading to more desirable locations at the venue, typically for an additional charge that can also be dynamic. Patrons can also be provided with tokens for each ticket; these tokens can be used for upgrades, for example, and can also be transferred to other patrons. Similarly, patrons may be offered compensation or other incentives if they are willing to downgrade for a particular event.

As described above, there may be a number of entry points 130, information access points 140 and the like (FIG. 2A). Through the use of ticket and/or marker objects, the role of these elements can be expanded, allowing patrons to change seats, remove holds on reserved seats, reserve additional seats, and the like, perhaps for a fee.

Because seats are being assigned dynamically, different purchasing options can also be provided. Season tickets, for example, typically require the holder to sit in the same location for each event. Instead, a book of tickets for a particular venue could be purchased, with the ticket holder finding seats using the dynamic seating process described herein, with refunds made as appropriate if the seats that are assigned do not match the purchase price. Alternatively, an option can be provided in which some portion of the tickets in the book are of higher value compared to the others; the holder could select which grade of ticket to use for which event, using higher value tickets for more popular events or for better seats. Similarly, instead of associating a ticket with a particular event, venues could offer tickets that are associated with something else. For example, tickets could be associated with a specific participant in an event; that is, for an event such as a tennis tournament, tickets could be associated with a particular player, allowing the ticket bearer to be admitted to each tournament event in which that player is playing.

It may also be possible, in some cases, to realize the privilege provided by marker objects as some sort of secure code (e.g., a secret number) that can be provided to interested parties. Different codes can be provided to different individuals, depending on the privilege to be granted. For example, different codes can be used to define different amounts of information that others may access; a person with access to all information can be given one code number, and a person with limited access can be given another code number. Thus, instead of having to present a marker object at an access point or the like, the secure code can be entered by speaking it, by using the touch pad on a telephone, or typing it in at a Web site, or the like, and the appropriate amount of information can be provided in response. This would allow passenger-specific information to be made available to others, for example.

Although embodiments of the present invention are described using examples pertaining to venues, events and air travel, it is appreciated that the present invention is not limited to such applications.

The preferred embodiment of the present invention is thus described. While the present invention has been described in particular embodiments, it should be appreciated that the present invention should not be construed as limited by such embodiments, but rather construed according to the following claims.

What is claimed is:

1. A ticketing method comprising:
providing a ticket object comprising identifying information;
providing a marker object associated with said ticket object, said marker object comprising information describing a relationship to said ticket object with reference to said identifying information, said marker object also comprising information defining a privilege provided by its association with said ticket object;
wherein said privilege is granted upon use of said marker object.

2. The method of claim 1 wherein information provided by said ticket object is in a format selected from the group consisting of an optically-readable format, an electronically-readable format, a mechanically-readable format and a magnetically-readable format.

3. The method of claim 1 wherein information provided by said marker object is in a format selected from the group consisting of an optically-readable format, an electronically-readable format, a mechanically-readable format and a magnetically-readable format.

4. The method of claim 1 wherein said identifying information identifies a group, wherein said privilege accords membership in said group.

5. The method of claim 1 comprising:
providing information about said group, wherein said information is printed on said ticket object.

6. The method of claim 1 wherein a first seating location is associated with said ticket object, wherein said privilege accords a second seating location in proximity to said first seating location.

7. The method of claim 1 wherein said privilege accords access to information that is otherwise inaccessible.

8. The method of claim 1 comprising:
providing a plurality of marker objects associated with said ticket object, wherein said marker objects define different privileges.

9. A ticketing system comprising:
a ticket object comprising identifying information; and
a marker object associated with said ticket object according to said identifying information, said marker object adapted for use independent from said ticket object, said marker object comprising information defining a privilege;
wherein said privilege is granted when said marker object is used.

10. The ticketing system of claim 9 wherein information provided by said ticket object is in a format selected from the group consisting of an optically-readable format, an electronically-readable format, a mechanically-readable format and a magnetically-readable format.

11. The ticketing system of claim 9 wherein information provided by said marker object is in a format selected from the group consisting of an optically-readable format, an electronically-readable format, a mechanically-readable format and a magnetically-readable format.

12. The ticketing system of claim 9 wherein said identifying information identifies a group, wherein said privilege provides membership in said group.

13. The ticketing system of claim 12 wherein information about said group is printed on said ticket object.

14. The ticketing system of claim 9 wherein a first seating location is associated with said ticket object, wherein said privilege provides a second seating location in proximity to said first seating location.

15. The ticketing system of claim 9 wherein said privilege provides access to information that is otherwise inaccessible.

16. The ticketing system of claim 9 comprising:
additional marker objects associated with said ticket object, wherein said additional marker objects define different privileges.

17. The ticketing system of claim 9 wherein said ticket object is not for a specific event but instead is for an event subject to constraints, said constraints selected from the group consisting of participating individuals, participating teams, time and location.

18. A method for dynamically assigning seating, comprising:
receiving identifying information supplied from a ticket object;
receiving information from a marker object separate from said ticket object, said information from said marker object comprising information affiliating said marker object and said ticket object provided said marker object is affiliated with said ticket object;
affiliating said marker object with said ticket object when said marker object is not affiliated with said ticket object;
associating a first seat and said ticket object; and
associating a second seat and said marker object.

19. The method of claim 18 wherein said first seat and said second seat are in proximity to each other.

20. The method of claim 18 comprising:
associating a particular time with said first seat and said second seat, wherein said first and second seats are reserved for use at said particular time.

21. The method of claim 18 wherein information provided by said ticket object and information provided by said marker object are in a format selected from the group consisting of an optically-readable format, an electronically-readable format, a mechanically-readable format and a magnetically-readable format.

22. The method of claim 18 wherein said identifying information identifies a group, wherein said affiliating comprises associating said marker object with said group.

23. The method of claim 22 comprising:
providing seating information for each member of said group, said seating information only given to members of said group.

24. The method of claim 22 comprising:
receiving information specifying a size of said group.

25. The method of claim 18 comprising:
providing an option allowing selection of a seating location different from an assigned seat location.

26. The method of claim 18 comprising:
providing an option allowing sale of a ticket object in return for compensation.

27. The method of claim 26 wherein said compensation varies according to time-dependent factors including supply and demand.

28. A method for securely exchanging information, comprising:
receiving information from a marker object having an affiliation with a ticket object, said information from said marker object comprising information identifying said affiliation; and
providing information pertaining to said ticket object in response to said receiving.

29. The method of claim 28 wherein said marker object also comprises information specifying an access level, wherein said information pertaining to said ticket object is provided in an amount corresponding to said access level.

30. The method of claim 28 wherein information pertaining to said ticket object and information received from said marker object are in a format selected from the group consisting of an optically-readable format, an electronically-readable format, a mechanically-readable format and a magnetically-readable format.
